(19) United States
(12) Patent Application Publication
(10) Pub. No.: US 2011/0187257 A1
(43) Pub. Date: Aug. 4, 2011

(54) DISCHARGE LAMP FOR VEHICLE

(75) Inventors: Masaya SHIDO, Shizuoka (JP); Toshiaki TSUDA, Shizuoka (JP)

(73) Assignee: KOITO MANUFACTURING CO., LTD., Tokyo (JP)

(21) Appl. No.: 13/010,235

(22) Filed: Jan. 20, 2011

(30) Foreign Application Priority Data
Feb. 2, 2010 (JP) 2010-021354

(51) Int. Cl. H01J 61/52; H01J 17/04

(52) U.S. Cl. 313/46; 313/632

(57) ABSTRACT

A discharge lamp for a vehicle has an external tube attached to a socket, a light emitting tube disposed in the external tube and formed of ceramic, the light emitting tube including a light emitting portion and a pair of narrow tube portions linked to the light emitting portion at opposite sides with the light emitting portion interposed therebetween, a cathode side electrode and an anode side electrode which are disposed in the light emitting tube, and two lead wires connected to the cathode side electrode and the anode side electrode respectively and having at least a part disposed in the external tube respectively. A length of the narrow tube portion on the cathode side being set to be smaller than that of the narrow tube portion on the anode side. The cathode side electrode being disposed on an opposite side to the socket with the anode side electrode interposed therebetween.

### CROSS REFERENCE TO RELATED APPLICATION(S)

This application is based upon and claims the benefit of priority from Japanese Patent Application No. 2010-021354 filed on Feb. 2, 2010, the entire contents of which are incorporated herein by reference.

### TECHNICAL FIELD

The present disclosure relates to a discharge lamp for a vehicle. More particularly, the invention relates to a technical field for reducing a length of a narrow tube portion on a cathode side to be smaller than that of a narrow tube portion on an anode side and disposing an cathode side electrode at an opposite side to a socket with an anode side electrode interposed therebetween, thereby enhancing a light distribution performance and a luminous efficiency.

### RELATED ART

Unlike a general illuminating lamp, a headlamp for a vehicle requires a fine light distribution control. For this reason, there is demanded a light emitting form which is uniform, is bar-shaped and has a high brightness ratio. Filaments of an incandescent lamp and a halogen lamp have the feature. Therefore, they have been used as light sources of a headlamp for a vehicle for a long period of time.

On the other hand, a headlamp for a vehicle which uses a discharge lamp as a light source has an advantage that a luminance can be enhanced because the discharge lamp has a larger light quantity as compared with an incandescent lamp and a halogen lamp, and the discharge lamp has a longer lifetime as compared with the incandescent lamp and the halogen lamp.

Thus, the discharge lamp has a higher luminance and a longer lifetime as compared with the incandescent lamp and the halogen lamp. In recent years, therefore, a headlamp for a vehicle including a discharge lamp using quartz glass has spread.

In the discharge lamp, generally, a light emitting tube which is formed of the quartz glass, holds a pair of electrodes and is filled with a gas such as an inert gas is disposed in an external tube which is intended for protecting a light emitting tube and stabilizing a temperature.

The light emitting tube is constituted by a light emitting portion for carrying out a discharge and a pair of narrow tube portions provided on sides opposite to each other with the light emitting portion interposed therebetween. The light emitting portion serves to generate an arc when the discharge is carried out, and has a larger diameter than that of the narrow tube portion.

Some light emitting tubes are formed of ceramic (for example, see Patent Document 1).

In the discharge lamp, a predetermined starting voltage is applied to the pair of electrodes and the discharge is carried out in a light emitting portion of a light emitting tube so that lighting is initiated.

In the discharge lamp, generally, an AC lighting method is used as a lighting method. The main reason is that mercury to be a filling substance and the other iodides are separated from each other in an arc so that a color separation is caused in the arc in case of a DC lighting method. In recent years, the DC lighting method is used in a discharge lamp which does not utilize mercury to be the main cause of the color separation according to some examples (for instance, see Patent Document 2).

In the discharge lamp using the DC lighting method, a pair of electrodes is set to be a cathode side electrode and an anode side electrode respectively, and a thermal electron discharged from the cathode side electrode collides with the anode side electrode in a generation of an arc.
[Patent Document 1] JP-T-2007-521620 Publication
[Patent Document 2] JP-A-2007-250225 Publication

However, a discharge lamp having a light emitting tube formed of ceramic seals the light emitting tube with low melting glass referred to as frit glass. For this reason, it is necessary to reduce a temperature of a sealed part. Consequently, there is employed a structure in which a length of a narrow tube portion is increased to seal a tip part thereof.

Accordingly, a total length of the light emitting tube is great. Therefore, there is an increased possibility that a light emitted from a light emitting portion might be shielded by a light emitting tube. As a result, a light distribution performance might be deteriorated in a structure of a headlamp for a vehicle.

Moreover, a luminous efficiency of the discharge lamp depends on the coldest point temperature in a light emitting tube. In the case in which the DC lighting method is used, however, a temperature on a cathode side is lower than that on an anode side. For this reason, it is necessary to raise the temperature on the cathode side which reaches the coldest point temperature, thereby enhancing the luminous efficiency.

### SUMMARY

Exemplary embodiments of the present invention provide a discharge lamp for a vehicle in which a light distribution performance and a luminous efficiency can be enhanced.

In order to solve the above mentioned problem, a discharge lamp for a vehicle in which a light emission is carried out by a DC lighting method, according to an exemplary embodiment, comprises:

an external tube attached to a socket;

a light emitting tube disposed in the external tube and formed of ceramic, the light emitting tube including a light emitting portion and a pair of narrow tube portions linked to the light emitting portion at opposite sides with the light emitting portion interposed therebetween;

a cathode side electrode and an anode side electrode which are disposed in the light emitting tube; and

two lead wires connected to the cathode side electrode and the anode side electrode respectively and having at least a part disposed in the external tube respectively,

wherein a length of the narrow tube portion on the cathode side being set to be smaller than that of the narrow tube portion on the anode side, and

wherein the cathode side electrode being disposed on an opposite side to the socket with the anode side electrode interposed therebetween.

In the discharge lamp for a vehicle, accordingly, the length of the narrow tube portion on the cathode side which is disposed on the opposite side to the socket with the anode side electrode interposed therebetween is smaller than that of the narrow tube portion on the anode side.

### ADVANTAGE OF THE INVENTION

A discharge lamp for a vehicle in which a light emission is carried out by a DC lighting method, according to the exemplary embodiment, comprises:

an external tube attached to a socket;

a light emitting tube disposed in the external tube and formed of ceramic, the light emitting tube including a light emitting portion and a pair of narrow tube portions linked to the light emitting portion at opposite sides with the light emitting portion interposed therebetween;

a cathode side electrode and an anode side electrode which are disposed in the light emitting tube; and

two lead wires connected to the cathode side electrode and the anode side electrode respectively and having at least a part disposed in the external tube respectively,

wherein a length of the narrow tube portion on the cathode side being set to be smaller than that of the narrow tube portion on the anode side, and

wherein the cathode side electrode being disposed on an opposite side to the socket with the anode side electrode interposed therebetween.

Accordingly, the cathode side electrode is rarely influenced by a thermal conduction from the lead wire so that a heat radiation is hard to perform. By disposing the cathode side electrode at the opposite side to the socket with the anode side electrode interposed therebetween, therefore, it is possible to suppress a reduction in a temperature, thereby enhancing a luminous efficiency.

By setting the length of the narrow tube portion on the cathode side to be smaller than that of the narrow tube portion on the anode side, moreover, a heat capacity in the narrow tube portion of the cathode side electrode is reduced. Consequently, a reduction in a temperature on the cathode side is suppressed so that the luminous efficiency can be enhanced still more.

Furthermore, by setting the length of the narrow tube portion on the cathode side to be smaller than that of the narrow tube portion on the anode side, a distance from the light emitting portion to a front end of the discharge lamp for a vehicle is shortened so that a light emitted from the light emitting portion and required for a light distribution pattern is prevented from being intercepted at the front end of the discharge lamp. Thus, it is possible to ensure an excellent light distribution performance.

Further, since the discharge lamp for a vehicle further comprises a heat insulating film formed in a position on an external surface of the light emitting tube where the cathode side electrode is covered, a temperature in a portion on the cathode side having the heat insulating film formed thereon in the light emitting tube is raised by a radiant heat from an arc. Consequently, it is possible to enhance a luminous efficiency.

Furthermore, in the discharge lamp for a vehicle, the heat insulating film is disposed in a position in which one end of the heat insulating film on the anode side does not protrude toward the anode side electrode from a tip of the cathode side electrode.

Accordingly, a light emitted from the light emitting portion and required for the light distribution pattern is prevented from being intercepted by the heat insulating film. Consequently, it is possible to prevent deterioration in a light distribution performance.

Furthermore, in the discharge lamp for a vehicle, the light emitting tube includes a thick portion which has a thickness greater than thicknesses of the other parts of the light emitting tube and is formed in a position of the light emitting tube where the cathode side electrode is covered. Therefore, strength of the light emitting tube is increased so that a leakage can be prevented from being caused over the light emitting portion in an early stage.

Furthermore, in the discharge lamp for a vehicle, the thick portion is disposed in a position in which one end of the thick portion on the anode side does not protrude toward the anode side electrode from a tip of the cathode side electrode.

Accordingly, the light emitted from the light emitting portion and required for the light distribution pattern is not transmitted through the thick portion. Consequently, it is possible to prevent deterioration in the light distribution performance.

### BRIEF DESCRIPTION OF THE DRAWINGS

FIG. 1 is a schematic sectional view showing a headlamp for a vehicle, illustrating the best mode of a discharge lamp for a vehicle according to the invention together with FIGS. 2 to 4,

FIG. 2 is an enlarged side view showing the discharge lamp, a part of which is taken away,

FIG. 3 is an enlarged sectional view showing a part, and

FIG. 4 is an enlarged sectional view showing an example in which a thick portion is formed on a light emitting tube.

### DETAILED DESCRIPTION

The best mode for carrying out a discharge lamp for a vehicle according to the invention will be described below with reference to the accompanying drawings. The discharge lamp for a vehicle is provided in a headlamp for a vehicle.

A headlamp 1 for a vehicle is attached and disposed on both left and right ends at a front end of a car body.

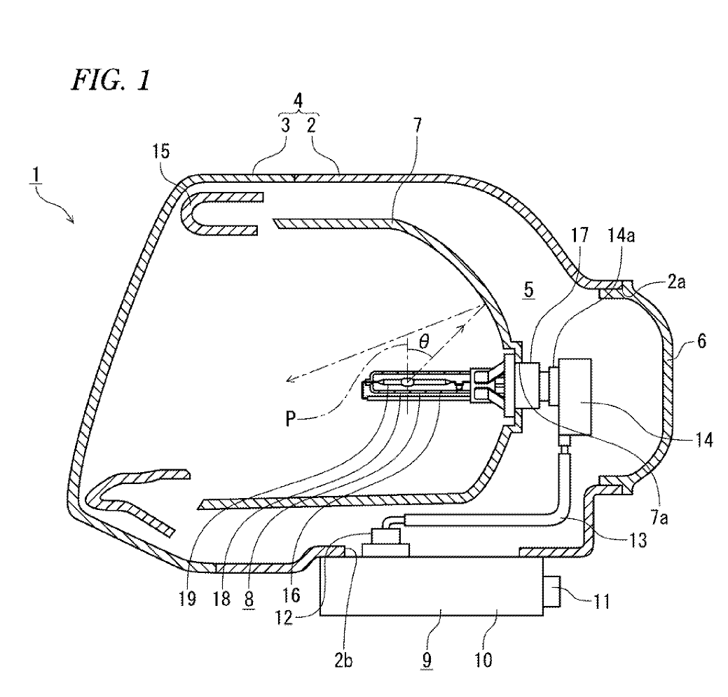

As shown in FIG. 1, the headlamp 1 for a vehicle includes a lamp housing 2 having a concave portion which is opened forward and a cover 3 for closing an open surface of the lamp housing 2, and a lighting device outer casing 4 is constituted by the lamp housing 2 and the cover 3. An internal space of the lighting device outer casing 4 is formed as a lighting chamber 5.

An inserting hole 2a penetrating longitudinally is formed on a rear end of the lamp housing 2 and is closed with a back cover 6. An arranging hole 2b penetrating vertically is formed on a lower end of the lamp housing 2.

A reflector 7 is tiltably supported in the lighting chamber 5 by means of an optical axis adjusting mechanism which is not shown. An attaching hole 7a penetrating longitudinally is formed on a rear end of the reflector 7.

A discharge lamp (a discharge lamp for a vehicle) 8 is attached into the attaching hole 7a of the reflector 7 in a horizontal state.

A discharge lamp lighting device 9 is attached into the arranging hole 2b of the lamp housing 2. The discharge lamp lighting device 9 is formed with a lighting circuit (not shown) accommodated in a case body 10. An input side connector 11 is provided on an outer peripheral surface of the case body 10, and an output side connector 12 is provided on an upper surface of the case body 10.

The input side connector 11 is connected to a power supplying circuit (not shown) through a connecting cord (not shown).

The output side connector 12 is connected to a starting device 14 through a feeding cord 13, and a connector 14a of the starting device 14 is connected to a socket of the discharge lamp 8 which will be described below.

The discharge lamp 8 is turned on by raising a source voltage of the power supplying circuit through the lighting circuit of the discharge lamp lighting device 9 and applying a starting voltage to the discharge lamp 8 through the feeding cord 13 and the starting device 14 to commence a discharge. As a lighting method for the discharge lamp 8, a DC lighting method is used.

An extension 15 is disposed in the lighting chamber 5. The extension 15 serves to shield a part of each portion disposed in the lighting chamber 5. A shade (not shown) for intercepting a part of a light emitted from the discharge lamp 8 is disposed in the lighting chamber 5.

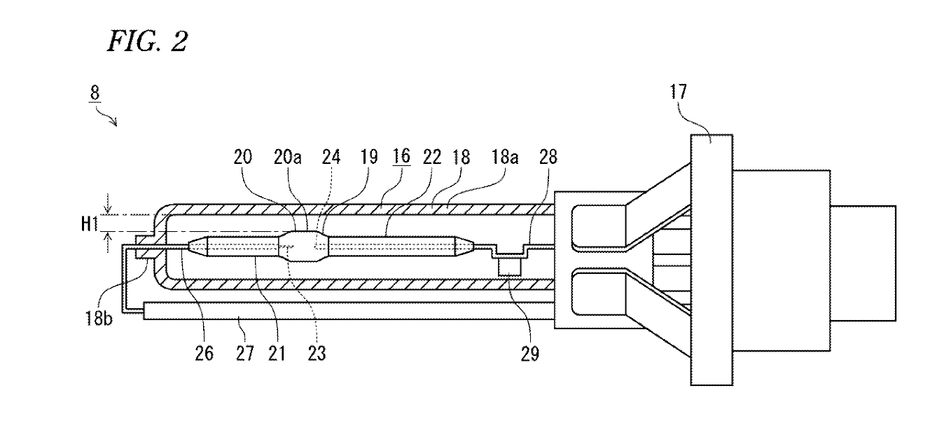

The discharge lamp 8 is constituted by connecting a body 16 to a socket 17 (see FIG. 2).

The body 16 has an external tube 18 and a light emitting tube 19 disposed in the external tube 18. The light emitting tube 19 is formed of ceramic.

The external tube 18 is constituted by integrally forming a closing portion 18a for covering the light emitting tube 19 and a holding portion 18b protruded forward from a front end of the closing portion 18a.

The light emitting tube 19 is formed by a light emitting portion 20 and narrow tube portions 21 and 22 which are linked to both front and rear ends of the light emitting portion 20, respectively. The narrow tube portions 21 and 22 are formed almost cylindrically and extended longitudinally respectively and have outside diameters which are smaller than an outside diameter of the light emitting portion 20. The narrow tube portion 21 positioned on a front side has a smaller length in a longitudinal direction than that of the narrow tube portion 22 positioned on a rear side.

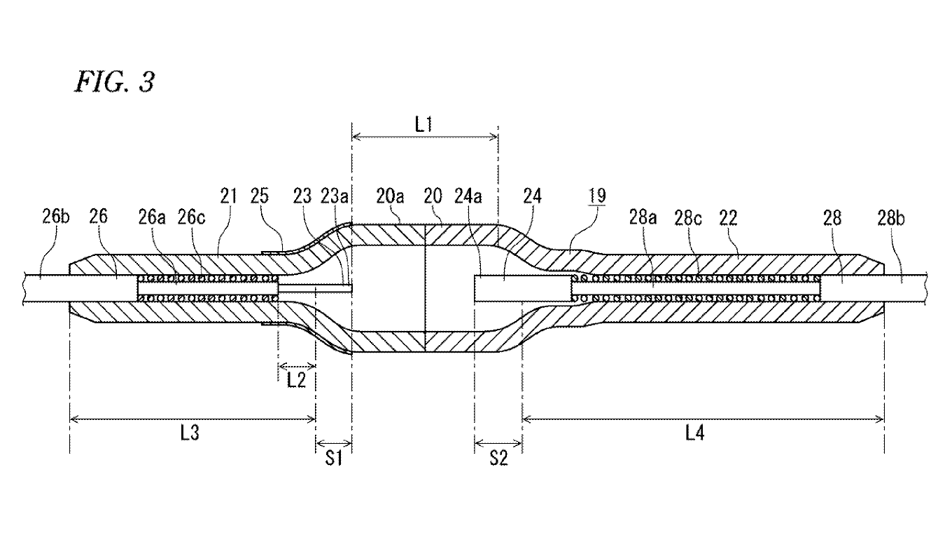

An iodide and an inert gas such as xenon or argon are filled in the light emitting portion 20 and each of the ends at the light emitting portion 20 side of the narrow tube portions 21 and 22. An intermediate portion in a longitudinal direction of the light emitting portion 20 is provided as a flat portion 20a extended longitudinally and taking an almost cylindrical shape (see FIG. 3). A length L1 in the longitudinal direction of the flat portion 20a is set to be equal to or greater than 2.0 mm.

A cathode side electrode 23 and an anode side electrode 24 which are formed to be longitudinally long respectively are disposed apart from each other in a longitudinal direction in the narrow tube portions 21 and 22. A rear end 23a of the electrode 23 on the cathode side and a front end 24a of the electrode 24 on the anode side are positioned in the light emitting portion 20 of the external tube 18.

As described above, in the discharge lamp 8, a DC lighting method is used as a lighting method, and a thermal electron discharged from the cathode side electrode 23 on the collides with the anode side electrode 24 in a generation of an arc so that a temperature of the anode side electrode 24 is raised. Consequently, it is possible to prevent erosion of an electrode by increasing an electrode diameter to be greater than that of the cathode side electrode 23 or increasing a heat capacity.

A protrusion amount S1 of the cathode side electrode 23 from the narrow tube portion 21 toward the light emitting portion 20 side is set to be equal to or smaller than 2.0 mm. A protrusion amount S2 of the anode side electrode 24 from the narrow tube portion 22 toward the light emitting portion 20 side is set to be equal to or greater than 2.0 mm.

A space is formed between an inner peripheral surface of the narrow tube portion 21 and an outer peripheral surface of the cathode side electrode 23, and a length L2 in a longitudinal direction of the space is set to be equal to or smaller than 1.0 mm.

A heat insulating film 25 is formed on an outer peripheral surface from a front end of the light emitting portion 20 to a rear end of the narrow tube portion 21. The heat insulating film 25 has an effect for absorbing or reflecting a visible light or an infrared light, thereby suppressing a reduction in a temperature of a portion of the light emitting tube 19 in which the cathode side electrode 23 is disposed, and has a rear end which is coincident with a rear end of the cathode side electrode 23, for example. The heat insulting film 25 may be formed in such a manner that the rear end is positioned on a front side of the rear end of the cathode side electrode 23.

A first lead wire 26 is connected to a front end of the cathode side electrode 23 (see FIGS. 2 and 3). The first lead wire 26 has a portion which is protruded forward from the narrow tube portion 21 on the front side of the light emitting tube 19, penetrates through the holding portion 18b and is protruded toward an outside of the external tube 18. The portion of the first lead wire 26 which is protruded toward the outside of the external tube 18 is bent in a predetermined direction and a rear end is connected to a first connecting terminal (not shown) which is provided on the socket 17.

The first lead wire 26 is constituted by a first portion 26a disposed in the narrow tube portion 21 and connected to the cathode side electrode 23 and a second portion 26b linked to a front end of the first portion 26a, and the first portion 26a is formed of molybdenum, for example, and the second portion 26b is formed of niobium, for example.

A molybdenum coil 26c is wound around the first portion 26a. A portion of the second portion 26b which is disposed in the narrow tube portion 21 is sealed with frit glass (low melting glass).

The first lead wire 26 is partially held in the holding portion 18b of the external tube 18, and a portion excluding a part in an outward protruded portion of the external tube 18 is covered with an insulating sleeve 27. The insulating sleeve 27 is formed by an insulating material such as glass or ceramic.

A second lead wire 28 extended almost longitudinally is connected to a rear end of the anode side electrode 24. The second lead wire 28 is protruded rearward from the narrow tube portion 22 at a rear side of the light emitting tube 19. A rear end of the second lead wire 28 is connected to a second connecting terminal (not shown) provided on the socket 17.

The second lead wire 28 is constituted by a first portion 28a disposed in the narrow tube portion 22 and connected to the anode side electrode 24, and a second portion 28b linked to a rear end of the first portion 28a. The first portion 28a is formed of molybdenum, for example, and the second portion 28b is formed of niobium, for example.

A molybdenum coil 28c is wound around the first portion 28a. A portion of the second portion 28b which is disposed in the narrow tube portion 22 is sealed with frit glass.

A getter 29 attached to the second lead wire 28 is disposed in the external tube 18. The getter 29 has a function for adsorbing an impurity (an impurity gas) which can be present in the external tube 18 and preventing a reduction in a luminous efficiency during a lifetime.

In the discharge lamp 8, an interval H1 between an inner peripheral surface of the external tube 18 and an outer peripheral surface of the flat portion 20a in the light emitting portion 20 is set to be equal to or smaller than 1.0 mm (see FIG. 2). Moreover, an argon gas is filled as a shroud gas in a space on an outside of the light emitting tube 19 in the external tube 18. The argon gas is set to have an atmospheric pressure of 0.3 atm to 0.9 atm.

In a discharge lamp (a discharge lamp for a vehicle), generally, it is necessary to enhance a luminous efficiency and to suppress arc bending generated in a light emitting portion in order to maintain an excellent light distribution performance. For this reason, a diameter of the light emitting portion is set to be small. When a diameter of the light emitting portion is reduced, however, a temperature in an upper part of the light emitting portion is raised so that a lifetime is inhibited from being prolonged due to a devitrification of a light emitting tube or a generation of a crack.

In the discharge lamp 8, therefore, the interval H1 between the inner peripheral surface of the external tube 18 and the outer peripheral surface of the flat portion 20a in the light emitting portion 20 is set to be equal to or smaller than 1.0 mm to enhance a heat radiating efficiency from the light emitting portion 20 to the external tube 19, thereby suppressing a rise in the temperature of the light emitting portion 20 as described above.

By filling the argon gas in the space on the outside of the light emitting tube 19 in the external tube 18, moreover, it is possible to ensure an excellent thermal transmitting property from the light emitting portion 20 to the external tube 19. In the discharge lamp 8, the atmospheric pressure of the argon gas is set to be 0.3 atm to 0.9 atm, thereby preventing a generation of a discharge in the space having the shroud gas filled therein and ensuring an air tightness of the space.

As described above, in the discharge lamp 8, the electrode 23 on the cathode side is positioned on the front side of the electrode 24 on the anode side, and the length in the longitudinal direction of the narrow tube portion 21 positioned on the front side is set to be smaller than that in the longitudinal direction of the narrow tube portion 22 positioned on the rear side.

The cathode side electrode 23 is rarely influenced by the thermal conduction from the lead wire and is hard to radiate a heat. Therefore, by disposing the cathode side electrode 23 at the front side it is possible to suppress a reduction in a temperature, thereby enhancing a luminous efficiency.

Further, more by setting the narrow tube portion 21 on the cathode side to be shorter than the narrow tube portion 22 on the anode side, it is possible to decrease a heat capacity in the narrow tube portion 21, thereby suppressing a reduction in a temperature on the cathode side to enhance a luminous efficiency still more.

For example, it is preferable that a length L3 of the narrow tube portion 21 on the cathode side and a length L4 of the narrow tube portion 22 on the anode side should be 0.4×L4≦L3≦0.8×L4 and 10 mm≦L4≦15 mm, respectively.

In other words, thermal stress of the sealed part at the transition region is increased when L3 is smaller than 0.4×L4. As a result, a crack or a leakage is generated so that lifetime durability is reduced. Moreover, a temperature of the sealed part is raised. Therefore, a filled substance such as an iodide reacts to frit glass and thus disappears so that an acting performance (a luminous flux maintenance rate) is also reduced.

On the other hand, when L3 is greater than 0.8×L4, the coldest point temperature in the light emitting tube is reduced. Therefore, a light emission of the filled substance is adversely influenced so that the luminous efficiency is reduced.

If the relationship between the length L3 of the narrow tube portion 21 on the cathode side and the length L4 of the narrow tube portion 22 on the anode side satisfies 0.4×L4≦L3≦0.8×L4 and 10 mm≦L4≦15 mm, a temperature of the sealed part is optimized, and accordingly it is possible to carry out a reaction of the filled substance such as an iodide and frit glass and a prevention of a crack or a leakage from being caused by a thermal stress. Furthermore, it is also possible to enhance a luminous efficiency through a rise in the coldest point temperature.

By setting the diameter of the narrow tube portion 21 to be smaller than that of the narrow tube portion 22 to reduce the heat capacity in the narrow tube portion 21, it is also possible to suppress a reduction in a temperature on the cathode side still more.

By setting the narrow tube portion 21 on the cathode side to be shorter than the narrow tube portion 22 on the anode side, moreover, it is possible to reduce the distance from the light emitting portion 20 to the front end of the discharge lamp 8, thereby intercepting a light emitted from the light emitting portion 20 and reflected by the reflector 7 with difficulty through the discharge lamp 8. Consequently, it is possible to ensure an excellent light distribution performance.

In the discharge lamp 8, as shown in FIG. 1, a light emitted at a rearward angle θ of approximately 55° or less with respect to a vertical line P is used as a light irradiated forward. It is desirable that the narrow tube portion 21 should be set to have such a length as not to intercept, through the discharge lamp 8, a light emitted within the range of the angle θ and reflected by the reflector 7.

As described above, the iodide is filled in the light emitting portion 20 and the ends of the narrow tube portions 21 and 22 at the light emitting portion 20 side. However, it is desirable that a filling amount of the iodide in the space on the cathode side should be increased and the iodide should be thus present at a high density in order to raise the coldest point temperature.

Therefore, in the discharge lamp 8, the length L2 in the longitudinal direction of the space which is present between the inner peripheral surface of the narrow tube portion 21 and the outer peripheral surface of the electrode 23 on the cathode side is set to be equal to or smaller than 1.0 mm as described above. Consequently, a volume of the space between the narrow tube portion 21 and the electrode 23 on the cathode side is reduced to cause the iodide to be present on the cathode side at a high density. Thus, it is possible to raise the coldest point temperature, thereby enhancing a luminous efficiency.

Moreover, the protrusion amount S1 of the cathode side electrode 23 from the narrow tube portion 21 toward the light emitting portion 20 side is set to be equal to or smaller than 2.0 mm. Consequently, a temperature of an internal wall in the light emitting tube on the cathode side is raised, resulting in an increase in the density of the iodide which is present in the space on the cathode side.

In the discharge lamp 8, as described above, the heat insulating film 25 is formed over the outer peripheral surface from the front end of the light emitting portion 20 to the rear end of the narrow tube portion 21. Accordingly, a temperature of the portion on the cathode side in the light emitting tube 19 where the heat insulating film 25 is formed is raised by the radiant heat from the arc. Thus, it is possible to enhance the luminous efficiency still more.

Furthermore, the range of formation of the heat insulating film 25 is set to be a range in which the rear end is coincident with the rear end of the electrode 23 on the cathode side. Consequently, a light emitted from the light emitting portion 20 and required for a light distribution pattern is not intercepted by the heat insulating film 25. Thus, it is possible to prevent a reduction in a light distribution performance.

In the discharge lamp 8, as described above, the density of the iodide which is present in the space on the cathode side is increased. However, there is a possibility that alumina (ceramic) to be a material for forming the light emitting tube 19 might be corroded by the iodide depending on the filling amount of the iodide to cause a leakage over the light emitting portion 20 in an early stage.

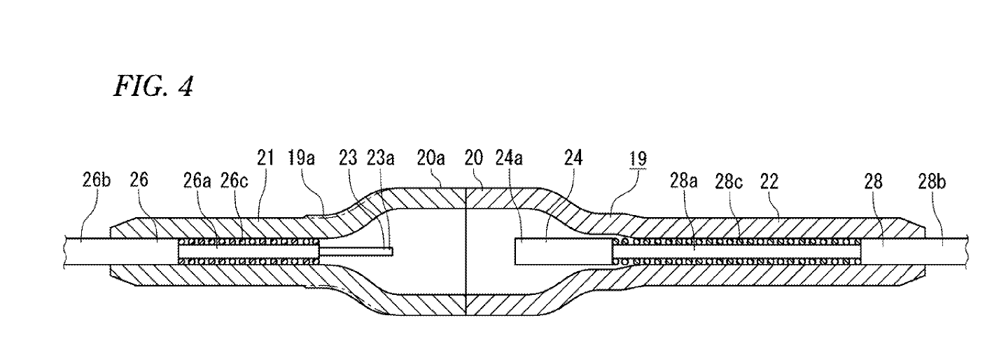

In the discharge lamp 8, therefore, it is desirable that the portion in the light emitting tube 19 which covers the cathode side electrode 23 should be formed as a thick portion 19a having a greater thickness than the thicknesses of the other parts of the light emitting tube 19 as shown in FIG. 4. Also in the case in which the thick portion 19a is formed, it is also possible to form the heat insulating film 25 on an outer periphery thereof.

By forming the thick portion 19a on the light emitting tube 19, strength of the light emitting tube 19 is thus increased. Consequently, it is possible to prevent the leakage from being caused over the light emitting portion 20 in the early stage.

Moreover, it is desirable that the range of formation of the thick portion 19a should be set into a range in which a rear end is coincident with the rear end of the cathode side electrode 23 in the same manner as the range of formation of the heat insulating film 25, and the light emitted from the light emitting portion 20 and required for the light distribution pattern should be prevented from being transmitted through the thick portion 19a.

In the discharge lamp 8, as described above, the light emitted at the rearward angle θ of approximately 55° or less with respect to the vertical line P is used as the light irradiated forward.

In the molding of the discharge lamp 8, in respect of a processing, a thickness of a bent part in the light emitting tube 19 is apt to be varied. Consequently, there is a possibility that a light transmitted through a portion having a thickness varied might not advance in a desirable direction, resulting in deterioration in the light distribution performance.

Therefore, in the discharge lamp 8, the light emitting portion 20 is provided with the flat portion 20a which is extended longitudinally by 2.0 mm or more and the protrusion amount S2 of the electrode 24 on the anode side from the narrow tube portion 22 is set to be equal to or greater than 2.0 mm, and the light emitted from the light emitting portion 20 at the angle θ of 55° or less is transmitted through the flat portion 20a to enhance the light distribution performance as described above.

Any shape and structure of each portion described in the best mode for carrying out the invention is only illustrative for concreteness in an execution of the invention. Consequently, the technical scope of the invention should not be construed to be restrictive.

What is claimed is:

1. A discharge lamp for a vehicle in which a light emission is carried out by a DC lighting method, comprising:
an external tube attached to a socket;
a light emitting tube disposed in the external tube and formed of ceramic, the light emitting tube including a light emitting portion and a pair of narrow tube portions linked to the light emitting portion at opposite sides with the light emitting portion interposed therebetween;
a cathode side electrode and an anode side electrode which are disposed in the light emitting tube; and
two lead wires connected to the cathode side electrode and the anode side electrode respectively and having at least a part disposed in the external tube respectively,
wherein a length of the narrow tube portion on the cathode side being set to be smaller than that of the narrow tube portion on the anode side, and
wherein the cathode side electrode being disposed on an opposite side to the socket with the anode side electrode interposed therebetween.

2. The discharge lamp for a vehicle according to claim 1, further comprising:
a heat insulating film formed in a position on an external surface of the light emitting tube where the cathode side electrode is covered.

3. The discharge lamp for a vehicle according to claim 2, wherein the heat insulating film is disposed in a position in which one end of the heat insulating film on the anode side does not protrude toward the anode side electrode from a tip of the cathode side electrode.

4. The discharge lamp for a vehicle according to claim 1, wherein the light emitting tube includes a thick portion which has a thickness greater than a thicknesses of the other parts of the light emitting tube and is formed in a position of the light emitting tube where the cathode side electrode is covered.

5. The discharge lamp for a vehicle according to claim 4, wherein the thick portion is disposed in a position in which one end of the thick portion on the anode side does not protrude toward the anode side electrode from a tip of the cathode side electrode.
